(19) United States
(12) Patent Application Publication
(10) Pub. No.: US 2004/0060252 A1
(43) Pub. Date: Apr. 1, 2004

(54) Drywall frame affixable corner bead and method

(76) Inventor: James Thomas Daly IV, Bonita Springs, FL (US)

Correspondence Address: Edward M. Livingston, Esq., 963 Trail Terrace Dr., Naples, FL, 34103, US

(21) Appl. No.: 10/260,828

(22) Filed: Sep. 27, 2002

(51) Int. Cl. E04B 2/00; E04C 1/00; B44F 7/00; B44F 9/00; E04C 2/38

(52) U.S. Cl. 52/312; 52/802.1; 52/716.1

(57) ABSTRACT

A drywall-frame-affixable corner bead has a corner-bead wall (1) with a corner-bead base that is affixed directly to corners of drywall framework (4) for extending the corner-bead wall outwardly to where outside surfaces of drywall (3) will be when the drywall is added later after the corner-bead base has been affixed securely to drywall framework. The corner bead can be shaped arcuately or otherwise as desired. Positional framework is extended intermediate the corner-bead wall and the corner-bead base for positioning the corner-bead walls at outside edges of drywall that is attached over the corner-bead base. A domed bead joint (17) is provided for three-sided bead corners. A use method includes affixing the corner-bead base to the drywall framework prior to attaching the drywall in order to position the corner-bead base intermediate the drywall and the drywall framework. A method for using the domed bead joint for three-sided drywall corners includes shaping corner slants (31) of the drywall to match edge walls of positional framework of the domed bead joints prior to attaching the three sides of drywall corners.

### BACKGROUND OF THE INVENTION

This invention relates to corner beads for drywall construction and in particular to corner beads that are affixed directly to drywall framework and projected outwardly to match drywall thicknesses before the drywall is attached to the drywall framework.

Conventional drywall beads at corners and edges of drywall are formed after drywall has been attached to drywall framework. This has required a further finishing function that is expensive in addition to its being delayed until after official approval of insulation behind the drywall framework, which increases total construction time and costs.

There are numerous known devices and methods for forming drywall-corner beads. None, however, provide a bead wall having a corner-bead base that is affixed directly to drywall framework for extending the bead wall outwardly to where outside surfaces of the drywall will be when the drywall is added later after the corner-bead base has been affixed securely to drywall framework in a manner taught by this invention.

Examples of most-closely related known but different devices without a corner bead having a corner-bead base affixed directly to drywall framework and other features of this invention are described in the following patent documents:

| U.S. Patent No. | Inventor | Issue Date |
|---|---|---|
| 5,544,463 | Bergin | Aug. 13, 1996 |
| 6,148,573 | Smythe, Jr. | Nov. 21, 2000 |
| 6,212,836 | Larson | Apr. 10, 2001 |
| 6,189,273 | Larson | Feb. 20, 2001 |
| 5,752,353 | Koenig, et al. | May 19, 1998 |
| 6,223,486 | Dunham | May 01, 2001 |
| 5,131,198 | Ritchie, et al. | Jul. 21, 1992 |
| 5,613,335 | Rennich, et al. | Mar. 25, 1997 |
| 6,295,776 | Kunz, et al. | Oct. 02, 2001 |
| 1,634,862 | Yoder | Jul. 05, 1927 |
| 6,352,382 | Hatlan, et al. | Mar. 05, 2002 |

### SUMMARY OF THE INVENTION

Objects of patentable novelty and utility taught by this invention are to provide a drywall-frame-affixable corner bead and method which:

provides a strong corner bead for drywall construction;

is adaptable to a plurality of known classes of drywall corners including without limitation, bullnose-shaped corners;

can be affixed directly to drywall framework before the drywall is applied to decrease construction time waiting for inspection approval of drywall framework and wall insulation prior to attachment of drywall to the drywall framework;

avoids need for finishing or optionally can be finished easily with painting or other covering;

can be protected with an adhered covering prior to use; and

prevents unevenness and joint lines at drywall corners.

This invention accomplishes these and other objectives with a drywall-frame-affixable corner bead having a corner-bead wall with a corner-bead base that is affixed directly to drywall framework. Positional framework extends the corner-bead wall outwardly to where outside surfaces of the drywall will be when the drywall is added later after the corner-bead base has been affixed securely to drywall framework. The corner-bead wall can be shaped arcuately or otherwise as desired.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a partially cutaway top view of the drywall-frame-affixable corner bead having a single corner-bead wall affixed to drywall framework behind ninety-degree corner walls and having bendable surfacing material adhered to a face of the corner-bead wall and to orthogonal edges of corner sheets of drywall;

FIG. 2 is an enlarged top view of the drywall-frame-affixable corner bead separately and having the bendable surfacing material, which can include paper, cloth-like or plastic sheeting, bent outwardly from adhered attachment to either a curved surface of the corner-bead wall or to positional framework to which the corner-bead wall is connected;

FIG. 3 is an enlarged top view of the FIG. 1 embodiment showing detail of affixment of the drywall-frame-affixable corner bead to the drywall framework behind drywall that is attached to the drywall framework and having the bendable surfacing material adhered to the curved face of the corner-bead wall and to the drywall adjacent to the corner-bead wall;

FIG. 4 is the FIG. 2 illustration showing detail of adherence of the bendable surfacing material to the positional framework of the corner-bead wall and showing fasteners for fastening a corner-bead base to the drywall framework;

FIG. 5 is the FIG. 4 illustration with the bendable surfacing material adhered to the corner-bead wall that is shown with dashed lines;

FIG. 6 is a side view of the drywall-frame-affixable corner bead as seen from a top side of the FIG. 4 illustration to show a convenient plurality of fastener orifices and a fastener in one of them for affixing the corner-bead wall to drywall framework;

FIG. 7 is a bottom view of the drywall-frame-affixable corner bead as seen from a bottom side of the FIG. 4 illustration to show the plurality of fastener orifices and showing the bendable surfacing material on the positional framework;

FIG. 8 is the bottom view of the drywall-frame-affixable corner bead as seen from the bottom side of the FIG. 4 illustration;

FIG. 9 is a partially cutaway front view of the drywall-frame-affixable corner bead and a domed-bead joint having three corner-bead walls attached to a top corner of three drywall surfaces;

FIG. 10 is a partially cutaway top view of the domed-bead joint having three corner-bead walls for attachment to a top corner of the three drywall surfaces;

FIG. 11 is a fragmentary end view of an arcuate corner-bead wall in relationship to the positional framework and base walls;

FIG. 12 is a fragmentary end view of a straight corner-bead wall in relationship to the positional framework and base walls;

FIG. 13 is a fragmentary end view of an angled corner-bead wall in relationship to the positional framework and base walls;

FIG. 14 is a partially cutaway side view of the drywall-frame-affixable corner bead affixed over drywall and having the surfacing material adhered to the drywall;

FIG. 15 is a partially cutaway side view of the drywall-frame-affixable corner bead and the domed bead joint in position for being assembled to be affixed over three surfaces of the drywall;

FIG. 16 is a top end view of the corner-bead wall positioned at an orthogonal corner of drywall sheets by the positional framework which is attached to drywall framework with an attachment base having a locator base wall;

FIG. 17 is a top end view of the corner-bead wall positioned on a wall edge or protrusion such as sides of an archway;

FIG. 18 is the FIG. 17 illustration with addition of an under-surface material; and

FIG. 19 a top end view of a corner of drywall sheets covered by the corner-bead wall at a side of a window.

### DESCRIPTION OF PREFERRED EMBODIMENT

Listed numerically below with reference to the drawings are terms used to describe features of this invention. These terms and numbers assigned to them designate the same features throughout this description.

| | |
|---|---|
| 1. | Corner-bead wall |
| 2. | Outside surfaces |
| 3. | Drywall |
| 4. | Drywall framework |
| 5. | First base wall |
| 6. | Second base wall |
| 7. | First bead edge |
| 8. | Second bead edge |
| 9. | First framework extension |
| 10. | Second framework extension |
| 11. | Filler support |
| 12. | Connector lip |
| 13. | Covering |
| 14. | Covering extension |
| 15. | Fastener aperture |
| 16. | Fastener |
| 17. | Domed bead joint |
| 18. | Joint ends |
| 19. | First bead wall |
| 20. | Second bead wall |
| 21. | Third bead wall |
| 22. | First edge plate |
| 23. | Second edge plate |
| 24. | Third edge plate |
| 25. | First corner-base wall |
| 26. | Second corner-base wall |
| 27. | Third corner-base wall |
| 28. | First edge wall |
| 29. | Second edge wall |
| 30. | Third edge wall |
| 31. | Corner slants |
| 32. | Convex arc |
| 33. | Plain surface |
| 34. | Angled corner |
| 35. | Attachment base wall |
| 36. | Locator base wall |
| 37. | Bead flat |
| 38. | Rigid support |
| 39. | Bead flat |
| 40. | Wall edge |
| 41. | Wall-edge extension |
| 42. | Window structure |
| 43. | Undersurface material |

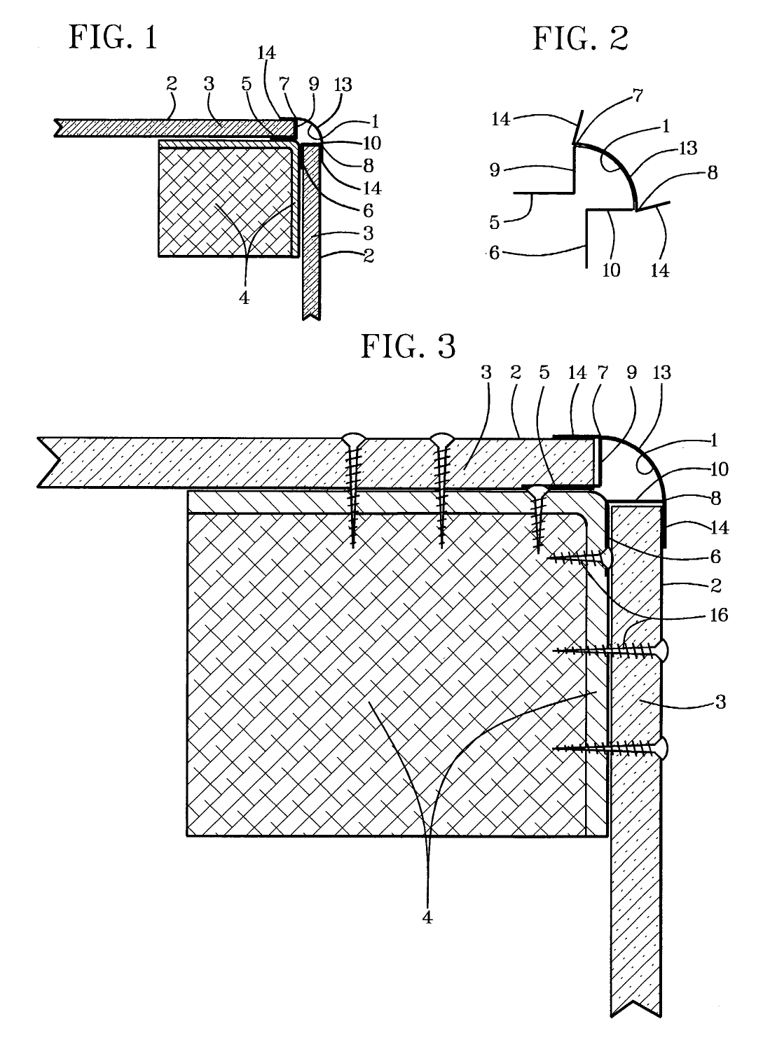

Referring to FIGS. 1-3, a drywall-affixable corner bead has at least one corner-bead wall 1 with shape and size for being extended intermediate edges of outside surfaces 2 of drywall 3 and related structure that is attachable to drywall framework 4. The drywall framework 4 can be metallic, wooden, plastic, other material or combinations thereof that may be devised and provided from-time-to-time for construction of inside walls for buildings.

At least one corner-bead base is affixable directly to the drywall framework 4. The corner-bead base has one or more base walls that can include a first base wall 5 and a second base wall 6. The corner-bead wall 1 can include a first bead edge 7 and a second bead edge 8.

Positional framework is extended predeterminedly intermediate the corner-bead base and the corner-bead wall 1. The positional framework for a large portion of applications can include a first framework extension 9 and a second framework extension 10. The first framework extension 9 is extended intermediate the first base wall 5 and the first bead edge 7. The second framework extension 10 is extended intermediate the second base wall 6 and the second bead edge 8.

Optionally, the positional framework can include a filler support 11 that can be flexible in combination with or in lieu of the first framework extension 9 and the second framework extension 10 as shown in FIG. 5.

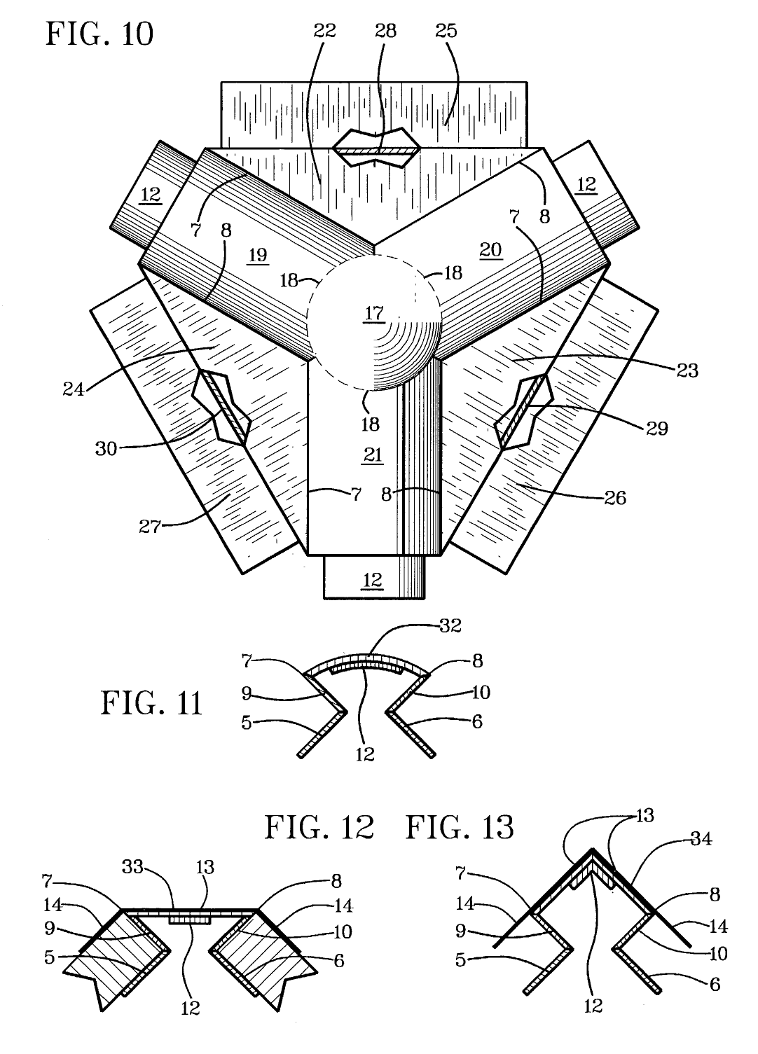

The corner-bead wall 1 can include a convex arc 32 as shown in FIG. 11, a plane surface 33 as shown in FIG. 12 or an angled corner 34 as shown in FIG. 13. Either can include a connector lip 12 as a bead-alignment member as shown in FIGS. 10-13 and 15.

The corner-bead wall 1 can be predeterminedly finished with coloring, covering or texture or a combination thereof that does not require further treatment or coloring. Optionally, the corner-bead wall 1 can be textured to receive coloring that includes painting.

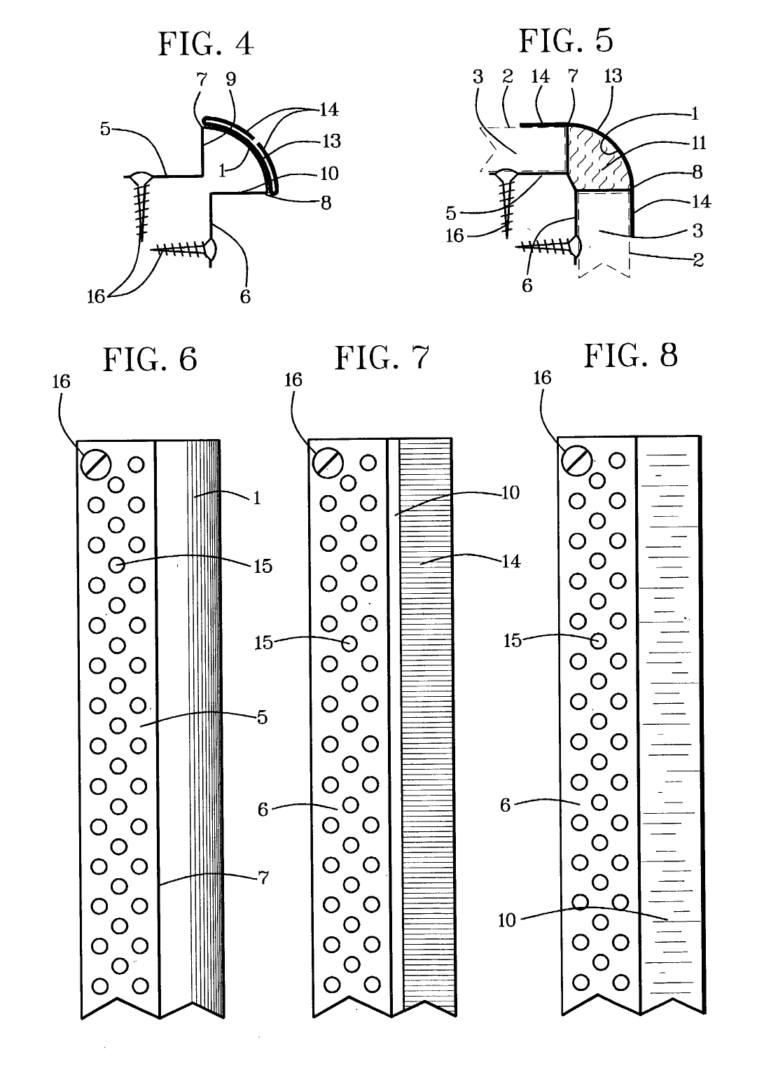

As shown in FIGS. 1-5 and 7, the corner-bead wall 1 can be predeterminedly covered with covering 13 intermediate the first bead edge 7 and the second bead edge 8. The covering 13 can include covering extensions 14 having covering adhesive on drywall sides of the covering extension 14. The covering extensions 14 can be adherent or can be made adherent to outside surfaces 2 of the drywall 3. Prior to being adhered to the outside surfaces 2 of the drywall 3, the covering extension 14 can be positioned against either the first framework extension 9 and the second framework extension 10, against the outside surface of the corner-bead wall 1 or not against either. FIG. 2 shows the covering extensions 14 without being fixed against either the corner-bead wall 1 and the first bead edge 7 and the second bead edge 8, or after being removed therefrom to be adhered to the outside surfaces 2 of the drywall 3.

As shown in FIGS. 6-8, the first base wall 5 and the second base wall 6 can include a plurality of fastener apertures 15 into which fasteners 16 can be inserted conveniently for affixing the corner-bead wall 1 directly to the drywall framework 4.

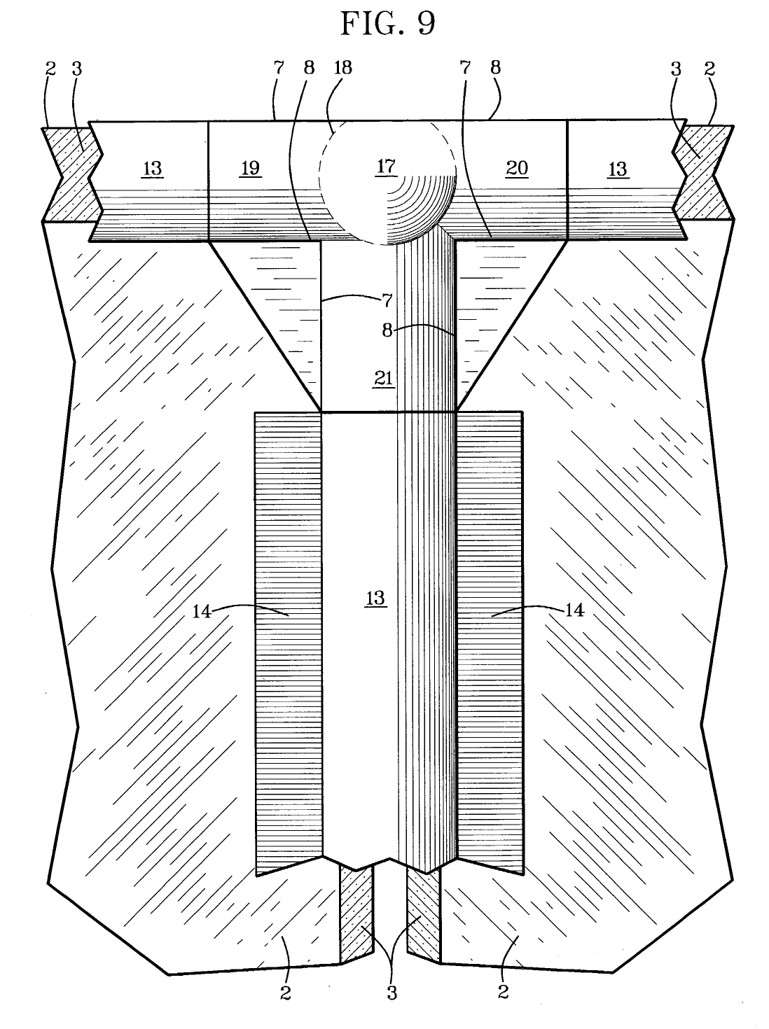

Referring to FIGS. 9-10, the at least one corner-bead wall 1 can include a domed bead joint 17 having a plurality of three corner-bead walls 1. The three corner-bead walls 1 each include the first bead edge 7 and the second bead edge 8. The three corner-bead walls 1 have joint ends 18 which are affixed to the domed bead joint 17 from which a first bead wall 19, a second bead wall 20 and a third bead wall 21 comprising the three corner-bead walls 1 are extended. The first bead edge 7 of the first bead wall 19 is orthogonal to the second bead edge 8 of the second bead wall 20. The first bead edge 7 of the second bead wall 20 is orthogonal to the second bead edge 8 of the third bead wall 21. The first bead edge 7 of the third bead wall 21 is orthogonal to the second bead edge 8 of the first bead wall 19.

As shown most clearly in FIG. 10, a first edge plate 22 is extended intermediate the first bead edge 7 of the first bead wall 19 and the second bead edge 8 of the second bead wall 20. A second edge plate 23 is extended intermediate the first bead edge 7 of the second bead wall 20 and the second bead edge 8 of the third bead wall 21. A third edge plate 24 is extended intermediate the first bead edge 7 of the third bead wall 21 and the second bead edge 8 of the first bead wall 19.

Also shown most clearly in FIG. 10, the corner-bead base includes a first corner-base wall 25, a second corner-base wall 26 and a third corner-base wall 27 that are affixable directly to the drywall framework 4. The positional framework for the domed bead joint 17 includes a first edge wall 28 extended from the first edge plate 22 to the first corner-base wall 25, a second edge wall 29 extended from the second edge plate 23 to the second corner-base wall 26 and a third edge wall 30 extended from the third edge plate 24 to the third corner-base wall 27.

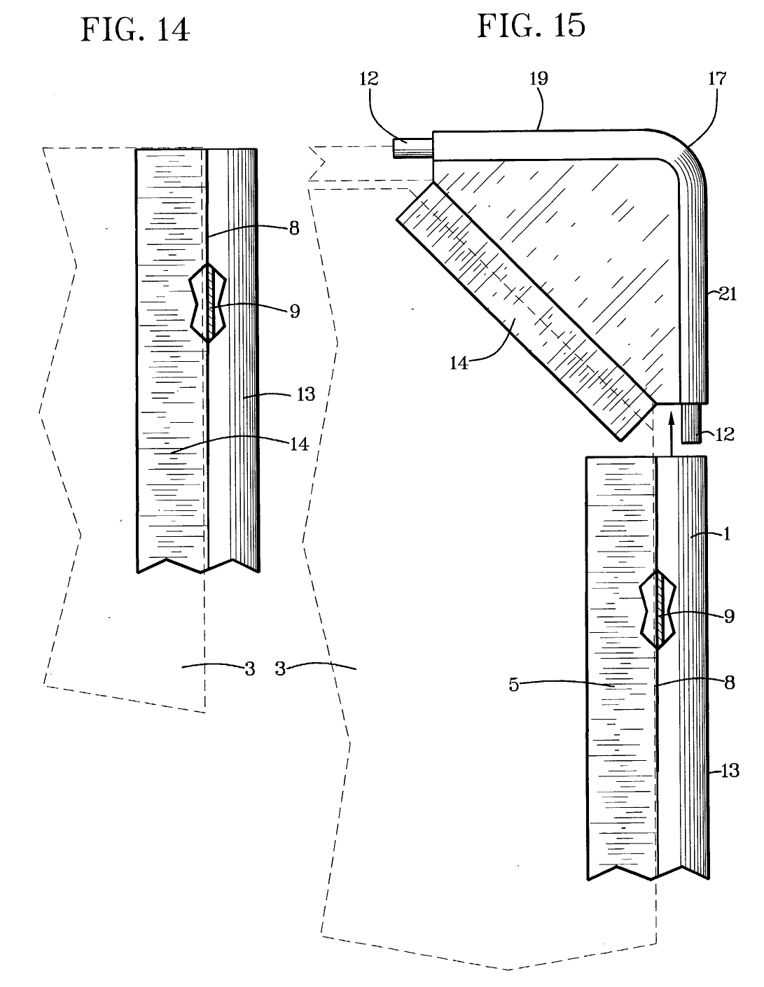

The drywall-frame-affixable corner bead having a single corner-bead wall 1 is affixed to two-wall corners of drywall 3 as shown separately in FIG. 14 or below the drywall-frame-affixable corner bead having the three corner bead walls 19-21 extending from the domed bead joint 17 as shown in FIG. 15. For affixing the three corner bead walls 19-21 extending from the domed bead joint 17, corner slants 31 on the drywall 3 are shaped to match wall slants of the first edge wall 28, the second edge wall 29 and the third edge wall 30.

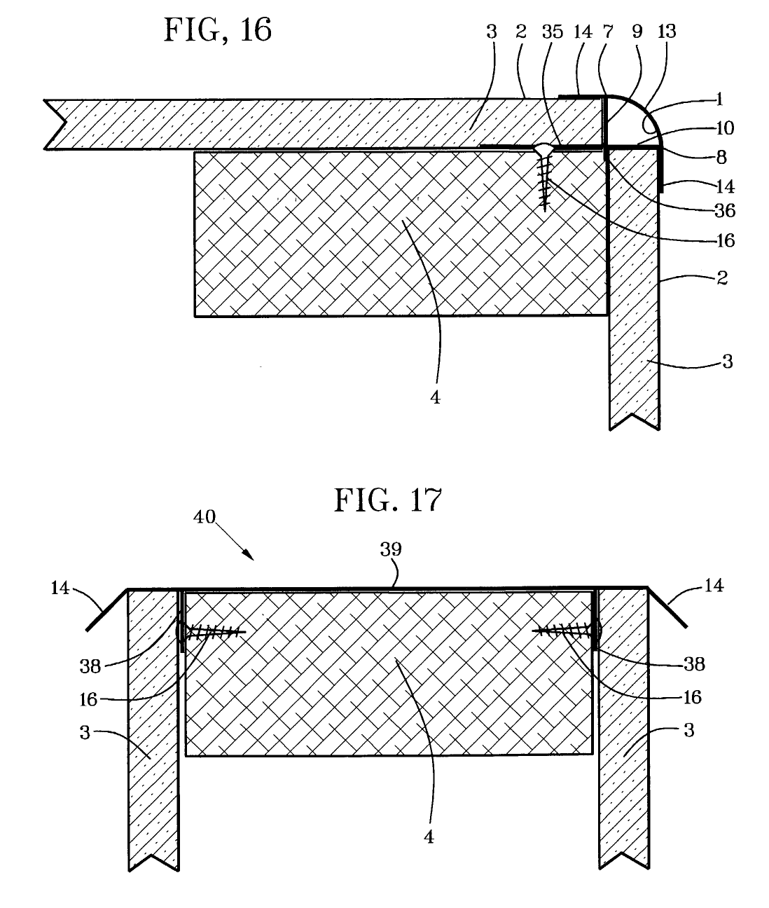

Referring to FIG. 16, the plurality of base walls of the corner-bead base 1 can include an attachment base wall 35 and a locator base wall 36. The locator base wall 36 is extended at a predetermined angle from a base end of the attachment base wall 35. The first framework extension 9 and the second framework extension 10 can be attached directly to the attachment base wall 35 proximate the locator base wall 36.

Referring to FIGS. 17-19, the positional framework can include a rigid support 38 that is extended intermediate the corner-bead base and an inside surface of the corner-bead wall 1. The rigid support 38 can be attached to the drywall framework 4 with the fasteners 16.

Embodiments with the rigid support 38 are intended primarily for irregular corners that are characteristic of windows, archways and doors.

As shown in FIG. 17, the corner-bead wall 1 can include a bead flat 39 having oppositely disposed sides extended from the rigid support 38. The rigid support 38 is extended at a predetermined angle from an attachment side of the bead flat 39 predeterminedly intermediate the oppositely disposed sides. The covering extension 14 can be extended from at least one side of the bead flat 39 for covering a wall edge 40 at an archway or similar structure.

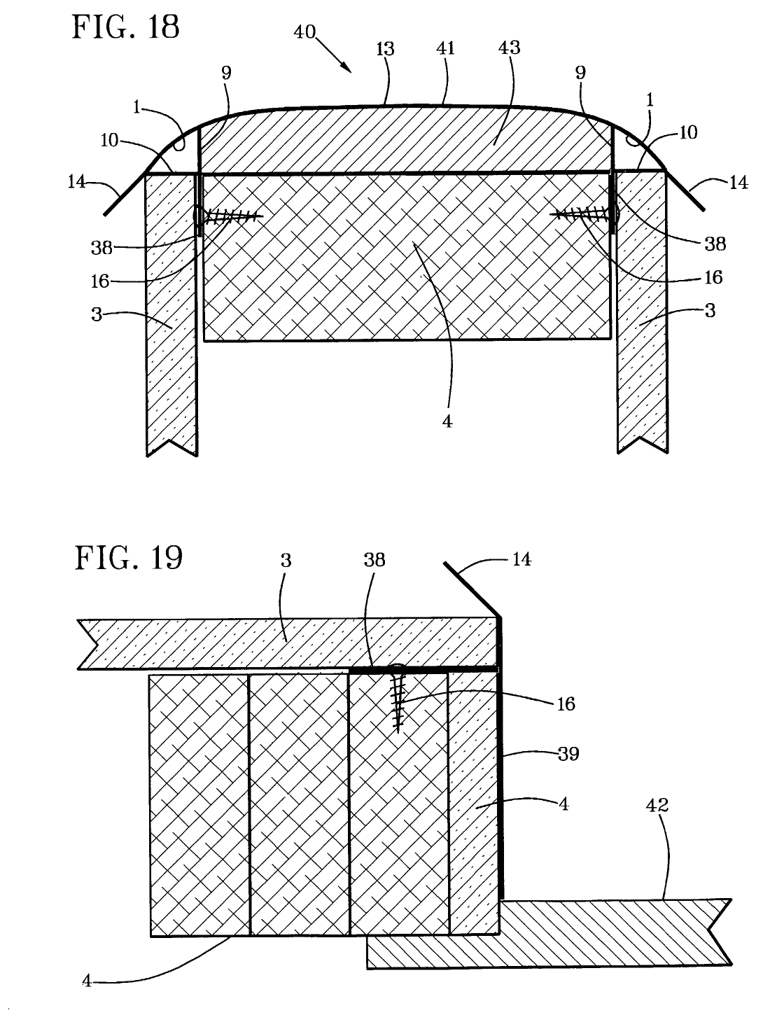

As shown in FIG. 18, the corner-bead wall 1 can include a wall-edge extension 41 that is extended over subsurface material 43 predeterminedly intermediate a first rigid support 38 that is attachable to a first side of a wall edge 40 and a second rigid support 38 that is attachable to a second side of the wall edge 40.

Referring to FIG. 19, the bead flat 39 attached to the rigid support 38 can be positioned on the drywall 3 at an edge of window structure 42.

A method is provided with steps for using a drywall-frame-fixable corner bead with at least one corner-bead wall having shape and size for being extended intermediate edge positions of outside surfaces of corners of drywall that is attachable to drywall framework; at least one corner-bead base that is affixable directly to the drywall framework; positional framework with extensions extended predeterminedly intermediate the corner-bead base and the corner-bead wall; and the positional framework having shape and size for positioning the corner-bead wall proximate the edge positions of the outside surfaces of the corners of the drywall predeterminedly.

The steps comprise:

affixing the corner-bead base 5, 6 directly to corners of the drywall framework 4 of a building under construction; and

attaching wall-corner edges of drywall 3 to the drywall framework 4 with the wall-corner edges of the drywall 3 being over the positional framework 9, 10 and the corner-bead base 5, 6 being intermediate the drywall 3 and the drywall framework 4.

The use method can relate to the drywall-frame-affixable corner bead wherein the bead corner includes a three-sided drywall corner and the drywall-frame-affixable corner bead includes a domed bead joint having a plurality of three corner-bead walls; the three corner-bead walls each include a first bead edge and a second bead edge; the three corner-bead walls have joint ends which are affixed to the domed bead joint from which a first bead wall, a second bead wall and a third bead wall comprising the three corner-bead walls are extended; the first bead edge of the first bead wall is orthogonal to the second bead edge of the second bead wall; the first bead edge of the second bead wall is orthogonal to the second bead edge of the third bead wall; the first bead edge of the third bead wall is orthogonal to the second bead edge of the first bead wall; a first edge plate is extended intermediate the first bead edge of the first bead wall and the second bead edge of the second bead wall; a second edge plate is extended intermediate the first bead edge of the second bead wall and the second bead edge of the third bead wall; a third edge plate is extended intermediate the first bead edge of the third bead wall and the second bead edge of the first bead wall; the corner-bead base includes a first corner-base wall, a second corner-base wall and a third corner-base wall that are affixable directly to the drywall framework; and the positional framework includes a first edge wall extended from the first edge plate to the first corner-base wall, a second edge wall extended from the second edge plate to the second corner-base wall and a third edge wall extended from the third edge plate to the third corner-base wall.

The steps include:

affixing the first corner-base wall 25 to the drywall framework 4;

affixing the second corner-base wall 26 to the drywall framework 4;

affixing the third corner-base wall 27 to the drywall framework 4;

shaping a corner slant 31 of a first panel of drywall 3 to match congruently and to fit against the first edge wall 28 of the positional framework;

attaching the first panel of drywall 3 to the drywall framework 4 with the first corner-base wall 25 being intermediate the first panel of drywall 3 and the drywall framework 4;

shaping the corner slant 31 of a second panel of the drywall 3 to match congruently and to fit against the second edge wall 29 of the positional framework;

attaching the second panel of the drywall 3 to the drywall framework 4 with the second corner-base wall 26 being intermediate the second panel of the drywall 3 and the drywall framework 4;

shaping the corner slant 31 of a third panel of the drywall 3 to match congruently and to fit against the third edge wall 30 of the positional framework; and

attaching the third panel of the drywall 3 to the drywall framework 4 with the third corner-base wall 27 being intermediate the third panel of the drywall 3 and the drywall framework.

A new and useful drywall-frame-affixable corner bead and method having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A drywall-frame-affixable corner bead comprising:
at least one corner-bead wall having shape and size for being extended intermediate edge positions of outside surfaces of corners of drywall that is attachable to drywall framework;
at least one corner-bead base that is affixable directly to the, drywall framework;
positional framework extended predeterminedly intermediate the corner-bead base and the corner-bead wall; and
the positional framework having shape and size for positioning the corner-bead wall proximate the edge positions of the outside surfaces of the corners of the drywall predeterminedly.

2. The drywall-frame-affixable corner bead of claim 1 wherein:
the corner-bead base includes a plurality of base walls.

3. The drywall-frame-affixable corner bead of claim 2 wherein:
the corner-bead wall includes a first bead edge and a second bead edge;

4. The drywall-frame-affixable corner bead of claim 3 wherein:
the plurality of base walls of the corner-bead base includes a first base wall and a second base wall.

5. The drywall-frame-affixable corner bead of claim 3 wherein:
the plurality of base walls of the corner-bead base includes an attachment base wall and a locator base wall; and
the locator base wall is extended at a predetermined angle from a base end of the attachment base wall.

6. The drywall-frame-affixable corner bead of claim 4 wherein:
the positional framework includes a first framework extension that is extended intermediate the first base wall and the first bead edge of the corner-bead wall; and
the positional framework includes a second framework extension that is extended intermediate the second base wall and the second bead edge of the corner-bead wall.

7. The drywall-frame-affixable corner bead of claim 6 wherein:
the corner-bead wall includes a convex arc intermediate the first bead edge and the second bead edge.

8. The drywall-frame-affixable corner bead of claim 6 wherein:
the corner-bead wall includes a plane surface intermediate the first bead edge and the second bead edge.

9. The drywall-frame-affixable corner bead of claim 6 wherein:
the corner-bead wall includes an angled corner intermediate the first bead edge and the second bead edge.

10. The drywall-frame-affixable corner bead of claim 6 wherein:
the corner-bead wall is predeterminedly finished intermediate the first bead edge and the second bead edge.

11. The drywall-frame-affixable corner bead of claim 6 wherein:
the corner-bead wall is predeterminedly covered with covering intermediate the first bead edge and the second bead edge.

12. The drywall-frame-affixable corner bead of claim 11 wherein:
the covering includes covering extensions having covering adhesive on drywall sides of the covering extension; and
the covering extensions are adherent to outside surfaces of the drywall with the covering adhesion.

13. The drywall-frame-affixable corner bead of claim 1 wherein:
the positional framework includes a filler support that is extended intermediate the corner-bead base and an inside surface of the corner-bead wall.

14. The drywall-frame-affixable corner bead of claim 1 wherein:
the positional framework includes a rigid support that is extended intermediate the corner-bead base and an inside surface of the corner-bead wall.

15. The drywall-frame-affixable corner bead of claim 14 wherein:
the rigid support includes the fastener for being attached to the drywall framework.

16. The drywall-frame-affixable corner bead of claim 14 wherein:
the corner-bead wall includes a bead flat having oppositely disposed sides extended at a predetermined angle from an axis of the rigid support.

17. The drywall-frame-affixable corner bead of claim 14 wherein:
the covering extension is extended from at least one side of the bead flat.

18. The drywall-frame-affixable corner bead of claim 14 wherein:
the corner-bead wall includes a wall-edge extension that is extended predeterminedly intermediate oppositely disposed sides of a wall edge.

19. The drywall-frame-affixable corner bead of claim 1 wherein:
the positional framework includes a first framework extension that is extended intermediate the corner-bead base and the first bead edge of the corner-bead wall; and
the positional framework includes a second framework extension that is extended intermediate the corner-bead base and the second bead edge of the corner-bead wall.

20. The drywall-frame-affixable corner bead of claim 19 wherein:
the corner-bead wall includes a convex arc intermediate the first bead edge and the second bead edge.

21. The drywall-frame-affixable corner bead of claim 19 wherein:
the corner-bead wall includes a plane surface intermediate the first bead edge and the second bead edge.

22. The drywall-frame-affixable corner bead of claim 19 wherein:
the corner-bead wall is predeterminedly finished intermediate the first bead edge and the second bead edge.

23. The drywall-frame-affixable corner bead of claim 19 wherein:
the corner-bead wall is predeterminedly covered with covering intermediate the first bead edge and the second bead edge.

24. The drywall-frame-affixable corner bead of claim 23 wherein:
the covering includes covering extensions having covering adhesive on drywall sides of the covering extension; and
the covering extensions are adherent to outside surfaces of the drywall with the covering adhesion.

25. The drywall-frame-affixable corner bead of claim 1 wherein:
the at least one corner-bead wall includes a domed bead joint having a plurality of three corner-bead walls;
the three corner-bead walls each include the first bead edge and a second bead edge;
the three corner-bead walls have joint ends which are affixed to the domed bead joint from which a first bead wall, a second bead wall and a third bead wall comprising the three corner-bead walls are extended;
the first bead edge of the first bead wall is orthogonal to the second bead edge of the second bead wall;
the first bead edge of the second bead wall is orthogonal to the second bead edge of the third bead wall;
the first bead edge of the third bead wall is orthogonal to the second bead edge of the first bead wall;
a first edge plate is extended intermediate the first bead edge of the first bead wall and the second bead edge of the second bead wall;
a second edge plate is extended intermediate the first bead edge of the second bead wall and the second bead edge of the third bead wall;
a third edge plate is extended intermediate the first bead edge of the third bead wall and the second bead edge of the first bead wall;
the corner-bead base includes a first corner-base wall, a second corner-base wall and a third corner-base wall that are affixable directly to the drywall framework; and
the positional framework includes a first edge wall extended from the first edge plate to the first corner-base wall, a second edge wall extended from the second edge plate to the second corner-base wall and a third edge wall extended from the third edge plate to the third corner-base wall.

26. The drywall-frame-affixable corner bead of claim 25 wherein:
the three corner-bead walls have terminal ends at predetermined distances from the domed bead joint; and
the terminal ends include bead-alignment members.

27. A method with steps for using a drywall-frame-fixable corner bead with at least one corner-bead wall having shape and size for being extended intermediate edge positions of outside surfaces of corners of drywall that is attachable to drywall framework; at least one corner-bead base that is affixable directly to the drywall framework; positional framework extended predeterminedly intermediate the corner-bead base and the corner-bead wall; and the positional framework having shape and size for positioning the corner-bead wall proximate the edge positions of the outside surfaces of the corners of the drywall predeterminedly;
the steps comprising:
affixing the corner-bead base directly to corners of the drywall framework of a building under construction; and
attaching wall-corner edges of drywall to the drywall framework with the wall-corner edges of the drywall being juxtaposed to the positional framework and the corner-bead base being intermediate the drywall and the drywall framework.

28. The method of claim 27 wherein the bead corner includes a three-sided drywall corner and the drywall-frame-affixable corner bead includes a domed bead joint having a plurality of three corner-bead walls; the three corner-bead walls each include a first bead edge and a second bead edge; the three corner-bead walls have joint ends which are affixed to the domed bead joint from which a first bead wall, a second bead wall and a third bead wall comprising the three corner-bead walls are extended; the first bead edge of the first bead wall is orthogonal to the second bead edge of the second bead wall; the first bead edge of the second bead wall is orthogonal to the second bead edge of the third bead wall; the first bead edge of the third bead wall is orthogonal to the second bead edge of the first bead wall; a first edge plate is extended intermediate the first bead edge of the first bead wall and the second bead edge of the second bead wall; a second edge plate is extended intermediate the first bead edge of the second bead wall and the second bead edge of the third bead wall; a third edge plate is extended intermediate the first bead edge of the third bead wall and the second bead edge of the first bead wall; the corner-bead base includes a first corner-base wall, a second corner-base wall and a third corner-base wall that are affixable directly to the drywall framework; and the positional framework includes a first edge wall extended from the first edge plate to the first corner-base wall, a second edge wall extended from the second edge plate to the second corner-base wall and a third edge wall extended from the third edge plate to the third corner-base wall;
the steps comprising:
affixing the first corner-base wall to the drywall framework;
affixing the second corner-base wall to the drywall framework;
affixing the third corner-base wall to the drywall framework;
shaping a corner slant of a first panel of drywall to match congruently and to fit against the first edge wall of the positional framework;
attaching the first panel of drywall to the drywall framework with the first corner-base wall being intermediate the first panel of drywall and the drywall framework;
shaping the corner slant of a second panel of the drywall to match congruently and to fit against the second edge wall of the positional framework;
attaching the second panel of the drywall to the drywall framework with the second corner-base wall being intermediate the second panel of the drywall and the drywall framework;
shaping the corner slant of a third panel of the drywall to match congruently and to fit against the third edge wall of the positional framework; and
attaching the third panel of the drywall to the drywall framework with the third corner-base wall being intermediate the third panel of the drywall and the drywall framework.
